(19) United States
(12) Patent Application Publication
(10) Pub. No.: US 2025/0165763 A1
(43) Pub. Date: May 22, 2025

(54) DYNAMICALLY SHAPING AND SEGMENTING WORK UNITS FOR PROCESSING IN NEURAL NETWORK PROCESSOR

(71) Applicant: APPLE INC, Cupertino, CA (US)

(72) Inventor: Christopher L. Mills, Saratoga, CA (US)

(73) Assignee: APPLE INC., Cupertino, CA (US)

(21) Appl. No.: 19/030,985

(22) Filed: Jan. 17, 2025

Related U.S. Application Data
(63) Continuation of application No. 15/971,786, filed on May 4, 2018.

(51) Int. Cl. G06N 3/063; G06F 13/16; G06F 17/15

(52) U.S. Cl. CPC G06N 3/063; G06F 13/1673; G06F 17/15

(57) ABSTRACT

Embodiments relate to a neural processor circuit that includes multiple neural engine circuits, a data buffer, and a kernel fetcher circuit. At least one of the neural engine circuits receives multiple sub-channels of a portion of input data from the data buffer. Neural engine circuit further receives a kernel of the one or more kernels from the kernel fetcher circuit, wherein the kernel was decomposed into a corresponding sub-kernel for each sub-channel of the portion of the input data. Neural engine circuit performs a convolution operation on each sub-channel of the portion of the input data and the corresponding sub-kernel. Neural engine circuit accumulates corresponding outputs of each sub-channel portion of the convolution operation to generate a single channel of the output data.

### CROSS-REFERENCE TO RELATED APPLICATION

The application is a continuation of U.S. patent application Ser. No. 15/971,786, filed May 4, 2018, which is incorporated by reference herein in its entirety.

### BACKGROUND

### 1. Field of the Disclosure

The present disclosure relates a circuit for performing convolution neural network and more specifically to systems and methods for dynamically shaping and segmenting work units in a neural network processor.

### 2. Description of the Related Arts

An artificial neural network (ANN) is a computing system or model that uses a collection of connected nodes to process input data. The ANN is typically organized into layers where different layers perform different types of transformation on their input. Extensions or variants of ANN such as convolution neural network (CNN), recurrent neural networks (RNN) and deep belief networks (DBN) have come to receive much attention. These computing systems or models often involve extensive computing operations including multiplication and accumulation. For example, CNN is a class of machine learning technique that primarily uses convolution between input data and kernel data, which can be decomposed into multiplication and accumulation operations.

Depending on the types of input data and operations to be performed, these machine learning systems or models can be configured differently. Such varying configuration would include, for example, pre-processing operations, number of channels in input data, kernel data to be used, non-linear function to be applied to convolution result, and applying of various post processing operations. Using a central processing unit (CPU) and its main memory to instantiate and execute machine learning systems or models of various configuration is relatively easy because such systems or models can be instantiated with mere updates to code. However, relying solely on the CPU for various operations of these machine learning systems or models would consume significant bandwidth of a central processing unit (CPU) as well as increase the overall power consumption.

### SUMMARY

Embodiments relate to a neural processor circuit including multiple neural engine circuits, a data buffer, and a kernel fetcher circuit. The neural engine circuits are configured to perform convolution operations on at least a work unit of input data and kernel data. The data buffer is placed between the neural engine circuits and a system memory external to the neural processor circuit. The data buffer stores at least a portion of the input data received from the system memory for sending to the neural engine circuits. The portion of the input data includes the work unit of the input data. The data buffer further stores output data received from the neural engine circuits. The kernel fetcher circuit is placed between the neural engine circuits and the system memory. The kernel fetcher circuit receives one or more kernels from the system memory, and sends a corresponding kernel to the neural engine circuits.

At least one of the neural engine circuits is configured to receive multiple sub-channels of the portion of the input data from the data buffer. The at least one neural engine circuit further receives a kernel of the one or more kernels from the kernel fetcher circuit, wherein the kernel was decomposed into a corresponding sub-kernel for each sub-channel of the portion of the input data. In one embodiment, the at least one neural engine circuit performs a convolution operation on each sub-channel of the portion of the input data and the corresponding sub-kernel. The at least one neural engine circuit accumulates corresponding outputs of each sub-channel portion of the convolution operation to generate a single channel of the output data.

### BRIEF DESCRIPTION OF THE DRAWINGS

FIG. 1 is a high-level diagram of an electronic device, according to one embodiment

FIG. 2 is a block diagram illustrating components in the electronic device, according to one embodiment.

FIG. 3 is a block diagram illustrating a neural processor circuit, according to one embodiment.

FIG. 4 is a block diagram of a neural engine in the neural processor circuit, according to one embodiment.

FIG. 5 is a conceptual diagram illustrating loops for processing input data at the neural processor circuit, according to one embodiment.

FIG. 6 is a conceptual diagram illustrating segmenting the input data into slices, tiles and work units, according to one embodiment.

FIG. 7 is a diagram illustrating programming of rasterizers in components of the neural processor circuit, according to one embodiment.

FIG. 8 is a flowchart illustrating a method of processing input data in a neural processor circuit, according to one embodiment.

FIG. 9A is a conceptual diagram illustrating a convolution operation with input stride reduction, according to one embodiment.

FIG. 9B is a conceptual diagram illustrating an example convolution between portion of input data and kernel data having spatial support of 5×5 with input stride reduction, according to one embodiment.

FIG. 10A illustrates an example of sub-channel swizzle for convolution with input stride reduction where subsampling of two is used in a horizontal direction, according to one embodiment.

FIG. 10B illustrates an example of broadcasting a portion of input data from a data buffer to a neural processor circuit as multiple sub-channels for input stride reduction, according to one embodiment.

FIG. 10C illustrates an example of arranging kernel data into sub-kernels having a swizzled order for convolution with input stride reduction, according to one embodiment.

FIG. 10D illustrates an example of zero-padding applied on a kernel and splitting the zero-padded kernel into multiple sub-kernels for convolution with input stride reduction, according to one embodiment.

FIG. 11A is a conceptual diagram illustrating a transposed convolution, according to one embodiment.

FIG. 11B is a conceptual diagram illustrating a transposed convolution with output stride expansion, according to one embodiment.

FIG. 11C illustrates an example of splitting a kernel into multiple sub-kernels for convolution with output stride expansion, according to one embodiment.

FIG. 12A illustrates an example of splitting a kernel into multiple sub-kernels for large kernel mode convolution, according to one embodiment.

FIG. 12B illustrates another example of splitting a kernel into multiple sub-kernels for large kernel mode convolution, according to one embodiment.

FIG. 13 is a flowchart illustrating a method of convolution with input stride reduction, according to one embodiment.

The figures depict, and the detail description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to performing convolution with input stride reduction, transposed convolution with output stride expansion, large kernel mode convolution operations, or convolution on small patches of input data. The input stride allows the convolution to skip input samples in a work unit of input data, which reduces resolution of output data compared to the input data. The output stride expansion is an inverse operation to the input stride reduction, which is used when running, e.g., an input-strided convolution backwards with a transposed kernel. Large kernel mode allows for utilizing kernels of sizes effectively doubled for both convolution and transposed convolution. Furthermore, convolution on small patches of input data implemented as presented herein increases utilization of a neural processor circuit when performing terminal segments of convolution neural network operations.

A processing cycle described herein refers to a time period for sending a work unit to a neural processing circuit and then performing a multiply-add operation on the work unit in a neural engine circuit of the neural processing circuit.

### Exemplary Electronic Device

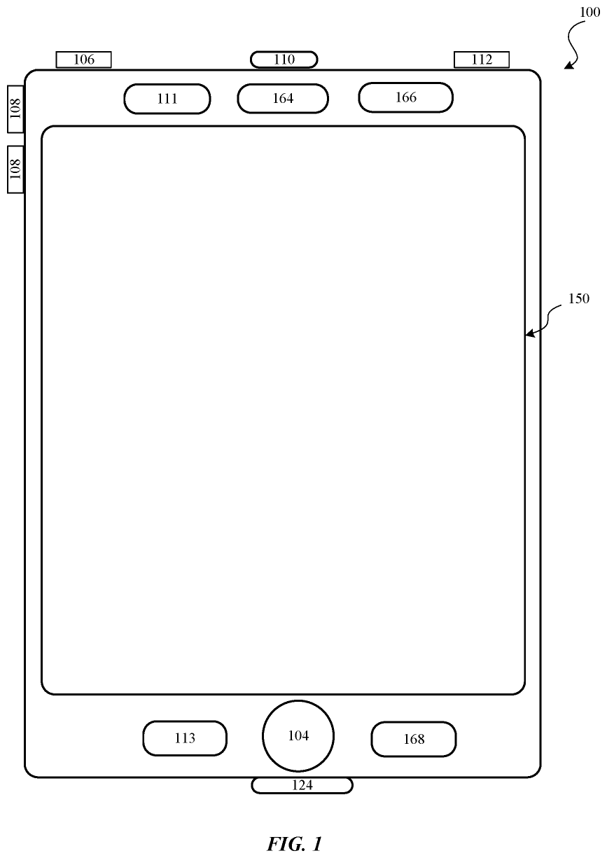

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communications device, but is a desktop computer or other computing device that is not designed for portable use. In some embodiments, the disclosed electronic device may include a touch sensitive surface (e.g., a touch screen display and/or a touch pad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. The device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. The device 100 may include components not shown in FIG. 1.

Device 100 is only one example of an electronic device, and device 100 may have more or fewer components than listed above, some of which may be combined into a components or have a different configuration or arrangement. The various components of device 100 listed above are embodied in hardware, software, firmware or a combination thereof, including one or more signal processing and/or application specific integrated circuits (ASICs).

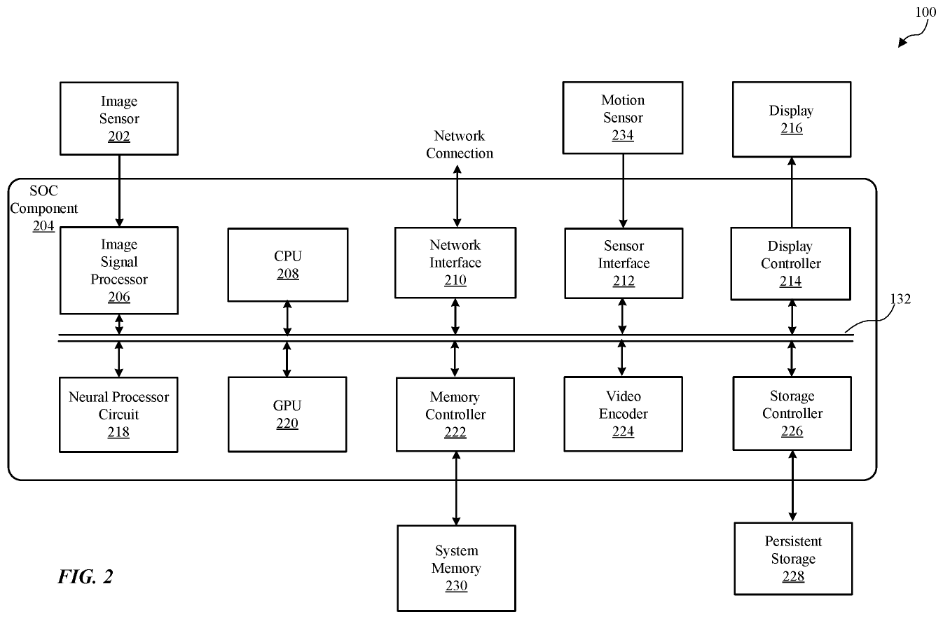

FIG. 2 is a block diagram illustrating components in device 100, according to one embodiment. Device 100 may perform various operations including image processing. For this and other purposes, the device 100 may include, among other components, image sensor 202, system-on-a chip (SOC) component 204, system memory 230, persistent storage (e.g., flash memory) 228, orientation sensor 234, and display 216. The components as illustrated in FIG. 2 are merely illustrative. For example, device 100 may include other components (such as speaker or microphone) that are not illustrated in FIG. 2. Further, some components (such as orientation sensor 234) may be omitted from device 100.

Image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern (hereinafter also referred to as “Bayer pattern”).

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. In some embodiments, system memory 230 may store pixel data or other image data or statistics in various formats.

Persistent storage 228 is a component for storing data in a non-volatile manner. Persistent storage 228 retains data even when power is not available. Persistent storage 228 may be embodied as read-only memory (ROM), flash memory or other non-volatile random access memory devices.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

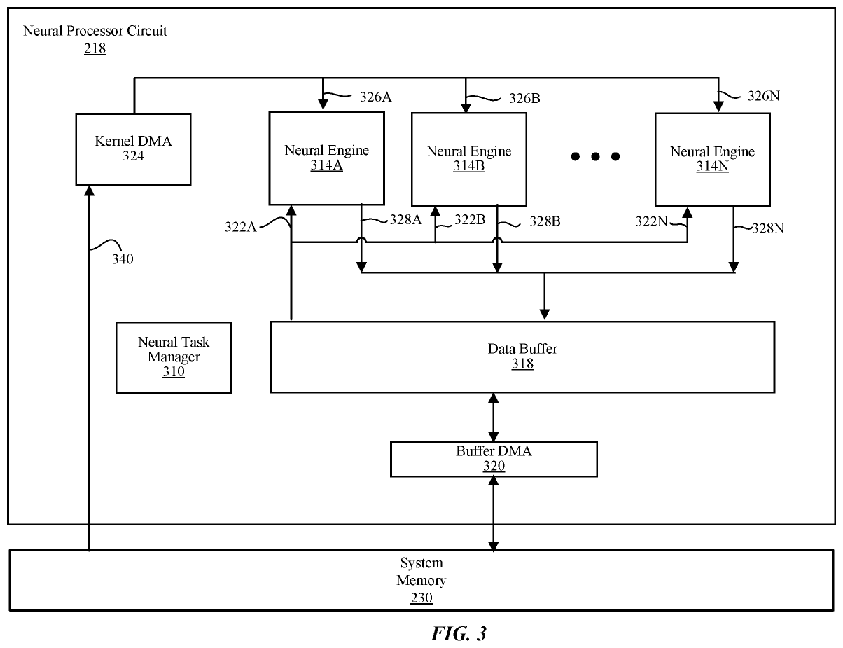

ISP 206 is hardware that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations, as described below in detail with reference to FIG. 3.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

Neural processor circuit 218 is a circuit that performs various machine learning operations based on computations including multiplication, adding and accumulation. Such computations may be arranged to perform, for example, convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 302, the image signal processor 206, system memory 230 or other sources such as network interface 210 or GPU 220. The output of neural processor circuit 218 may be provided to various components of device 100 such as the image signal processor 206, system memory 230 or CPU 208 for various operations. The structure and operation of neural processor circuit 218 is described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206, such as discussed below in FIG. 3) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of the device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 128 or for passing the data to network interface w10 for transmission over a network to another device.

In some embodiments, one or more subcomponents of SOC component 204 or some functionality of these subcomponents may be performed by software components executed on ISP 206, CPU 208 or GPU 220. Such software components may be stored in system memory 230, persistent storage 228 or another device communicating with device 100 via network interface 210.

Image data or video data may flow through various data paths within SOC component 204. In one example, raw image data may be generated from the image sensor 202 and processed by ISP 206, and then sent to system memory 230 via bus 232 and memory controller 222. After the image data is stored in system memory 230, it may be accessed by video encoder 224 for encoding or by display 116 for displaying via bus 232.

### Example Neural Processor Circuit

Neural processor circuit 218 is a configurable circuit that performs neural network operations on the input data based at least on kernel data 340. For this purpose, neural processor circuit 218 may include, among other components, neural task manager 310, a plurality of neural engines 314A through 314N (hereinafter collectively referred as “neural engines 314” and individually also referred to as “neural engine 314”), kernel direct memory access (DMA) 324, data buffer 318 and buffer DMA 320. Neural processor circuit 218 may include other components not illustrated in FIG. 3.

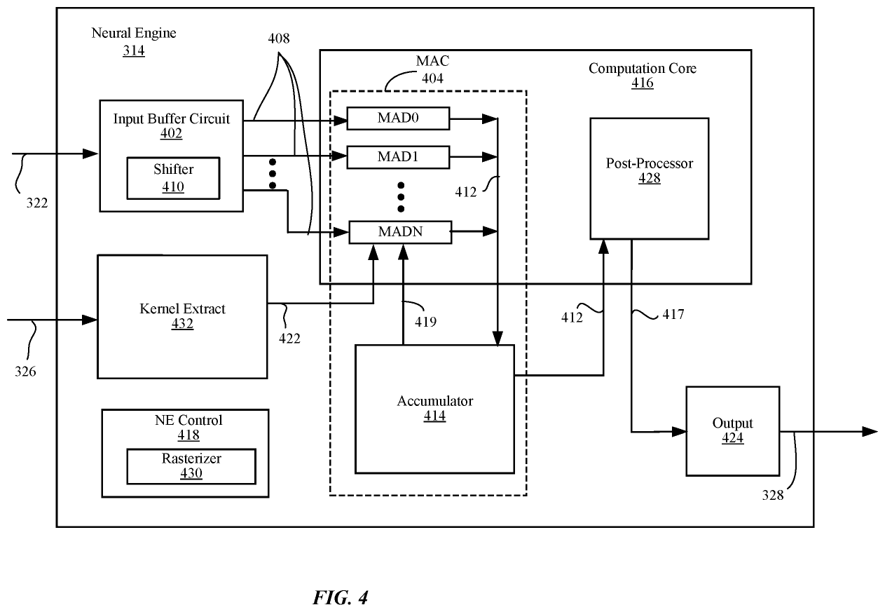

Each of neural engines 314 performs computing operations for neural network operations in parallel. Depending on the load of operation, entire set of neural engines 314 may be operated or only a subset of the neural engines 314 may be operated while the remaining neural engines 314 are placed in a power save mode to conserve power. Each of neural engines 314 includes components for storing one or more kernels, for performing multiply-accumulate operations, and for post-processing to generate an output data 328, as described below in detail with reference to FIG. 4. One example of a neural network operation is a convolution operation.

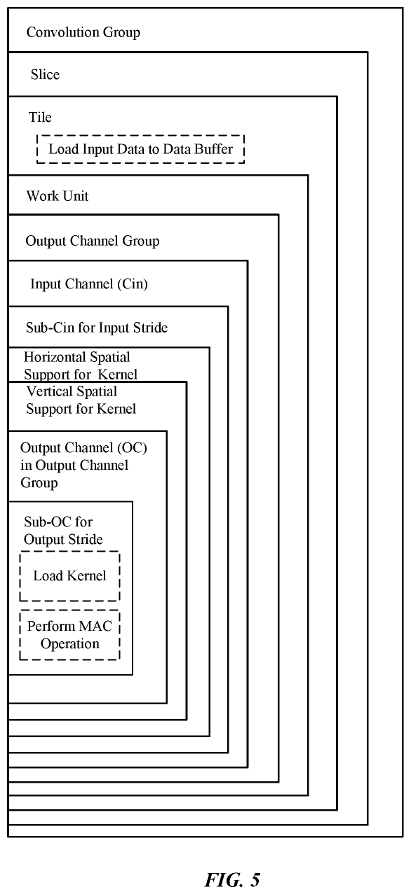

Neural task manager 310 manages the overall operation of neural processor circuit 218. Neural task manager 310 may receive a task list from a compiler executed by CPU 208, store tasks in its task queues, choose a task to perform, and send instructions to other components of the neural processor circuit 218 for performing the chosen task. Neural task manager 310 may also perform switching of tasks on detection of events such as receiving instructions from CPU 208. In one or more embodiments, the neural task manager 310 sends rasterizer information to the components of the neural processor circuit 218 to enable each of the components to track, retrieve or process appropriate portions of the input data and kernel data, as described below in detail with reference to FIGS. 5 through 7. Although neural task manager 310 is illustrated in FIG. 3 as part of neural processor circuit 218, neural task manager 310 may be a component outside the neural processor circuit 218.

Kernel DMA 324 is a read circuit that fetches kernel data from a source (e.g., system memory 230) and sends kernel data 326A through 326N to each of the neural engines 314. Kernel data represents information from which kernel elements can be extracted. In one embodiment, the kernel data may be in a compressed format which is decompressed at each of neural engines 314. Although kernel data provided to each of neural engines 314 may be the same in some instances, the kernel data provided to each of neural engines 314 is different in most instances.

Data buffer 318 is a temporary storage for storing data associated with the neural network operations. In one embodiment, data buffer 318 is embodied as a memory that can be accessed by all of the neural engines 314. Data buffer 318 may store input data 322A through 322N for feeding to corresponding neural engines 314A through 314N, as well as output from each of neural engines 314A through 314N for feeding back into neural engines 314 or sending to a target circuit (e.g., system memory 230). The operations of data buffer 318 and other components of the neural processor circuit 218 are coordinated so that the input data and intermediate data stored in the data buffer 318 is reused across multiple operations at the neural engines 314, and thereby reduce data transfer to and from system memory 230. Data buffer 318 may be operated in a broadcast mode where data input data of all input channels are fed to all neural engines 314 or in a unicast mode where data input data of a subset of input channels are fed to each neural engine 314.

The input data 322 stored in data buffer 318 may be part of, among others, image data, histogram of oriented gradients (HOG) data, audio data, meta data, output data 328 of a previous cycle of the neural engine 314, and other processed data received from other components of the SOC component 204. Further, input data 322 may refer to all of the data stored in data buffer 318 or one or more portions of the input data stored in data buffer 318.

Buffer DMA 320 includes a read circuit that receives a portion (e.g., tile) of the input data from a source (e.g., system memory 230) for storing in data buffer 318, and a write circuit that forwards data from data buffer 138 to a target (e.g., system memory).

### Example Neural Engine Architecture

FIG. 4 is a block diagram of the neural engine 314, according to one embodiment. The neural engine 314 performs various operations to facilitate neural network operations such as convolution, spatial pooling and local response normalization. The neural engine 314 receives the input data 322, performs multiply-accumulate operations (e.g., convolution operations) on the input data 322 based on stored kernel data, performs further post-processing operations on the result of the multiply-accumulate operations, and generates the output data 328. The input data 322 and/or the output data 328 of the neural engine 314 may be of a single channel or multiple channels.

Neural engine 314 may include, among other components, input buffer circuit 402, computation core 416, neural engine (NE) control 418, kernel extract circuit 432, accumulators 414 and output circuit 424. Neural engine 314 may include further components not illustrated in FIG. 4.

Input buffer circuit 402 is a circuit that stores a portion of the input data 322 as it is received from the data buffer 318 and sends an appropriate portion 408 of input data for a current task or process loop to computation core 416 for processing. Input buffer circuit 402 includes a shifter 410 that shifts read locations of input buffer circuit 402 to change the portion 408 of input data sent to computation core 416. By changing portions of input data provided to the computation core 416 via shifting, neural engine 314 can perform multiply-accumulate for different portions of input data based on fewer number of read operations. In one or more embodiments, the input data 322 includes data of difference convolution groups and/or input channels.

Kernel extract circuit 432 is a circuit that receives kernel data 326 from kernel DMA 324 and extracts kernel coefficients 422. In one embodiment, the kernel extract circuit 432 references a look up table (LUT) and uses a mask to reconstruct a kernel from compressed kernel data 326. The mask indicates locations in the reconstructed kernel to be padded with zero and remaining locations to be filled with numbers. The kernel coefficients 422 of the reconstructed kernel are sent to computation core 416 to populate register in multiply-add (MAD) circuits of computation core 416. In other embodiments, the kernel extract circuit 432 receives kernel data in an uncompressed format and the kernel coefficients are determined without referencing a LUT or using a mask.

Computation core 416 is a programmable circuit that performs computation operations. For this purpose, the computation core 416 may include MAD circuits MADO through MADN and a post-processor 428. Each of MAD circuits MADO through MADN may store an input value in the portion 408 of the input data and a corresponding kernel coefficient in the kernel coefficients 422. The input value and the corresponding kernel coefficient are multiplied in each of MAD circuits to generate a processed value 412.

Accumulator 414 is a memory circuit that receives and stores processed values 412 from MAD circuits. The processed values stored in accumulator 414 may be sent back as feedback information 419 for further multiply and add operations at MAD circuits or sent to post-processor 428 for post-processing. Accumulator 414 in combination with MAD circuits form a multiply-accumulator (MAC) 404. In one or more embodiments, accumulator 414 may have subunits where each subunit sends data to different components of neural engine 314. For example, during a processing cycle, data stored in a first subunit of accumulator 414 is sent to MAC circuit while data stored in a second subunit of accumulator 414 is sent to post-processor 428.

Post-processor 428 is a circuit that performs further processing of values 412 received from accumulator 414. The post-processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is output from the post-processor 428 as processed values 417 to output circuit 424.

NE control 418 controls operations of other components of the neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator 414 to MAD circuits, and perform different types of post-processing operations at post processor 428. To configure components of the neural engine 314 to operate in a desired manner, the NE control 418 sends control signal to components of the neural engine. NE control 418 may also include rasterizer 430 that tracks the current task or process loop being processed at neural engine 314, as described below in detail with reference to FIG. 5 through 7.

Output circuit 424 receives processed values 417 from the post-processor 428 and interfaces with data buffer 318 to store processed values 417 in data buffer 318. For this purpose, output circuit 424 may send out output data 328 in a sequence or a format that is different from the sequence or format in which the processed values 417 are processed in post-processor 428.

The components in the neural engine 314 may be configured during a configuration period by the NE control 418 and the neural task manager 310. For this purpose, the neural task manager 310 sends configuration information to the neural engine 314 during the configuration period. The configurable parameters and modes may include, but are not limited to, mapping between input data elements and kernel elements, the number of input channels, the number of output channels, performing of output strides, and enabling/selection of post-processing operations at the post processor 428.

### Operation of Segmenting of Data for Processing at Neural Processor Circuit

Input data is typically split into smaller pieces of data for parallel processing at multiple neural engines 314. Often multiple cycles of operations are performed to generate output for a task associated with a neural network. A compiler executed by CPU 208 analyzes the hierarchy and nodes of the neural network and determines how the input data is to be segmented based on the hardware constraints of the neural processor circuit 218. One of functions of the compiler is to determine how input data is to be split into smaller data units for processing at the neural engines 314, and how the processing is to be iterated in loops to produce the result for tasks.

FIG. 5 is a conceptual diagram illustrating loops for processing the input data at neural processor circuit 218, according to one embodiment. The outermost loop represents processing for a convolution group, if group convolution involving multiple convolution group is used. Group convolutions are convolutions where input data of the input channels in each group are used only for generating output data of output channels of each group but are not used for generating output data for output channels of other groups. Hence, each group of the group convolution can be treated as a separate convolution operation.

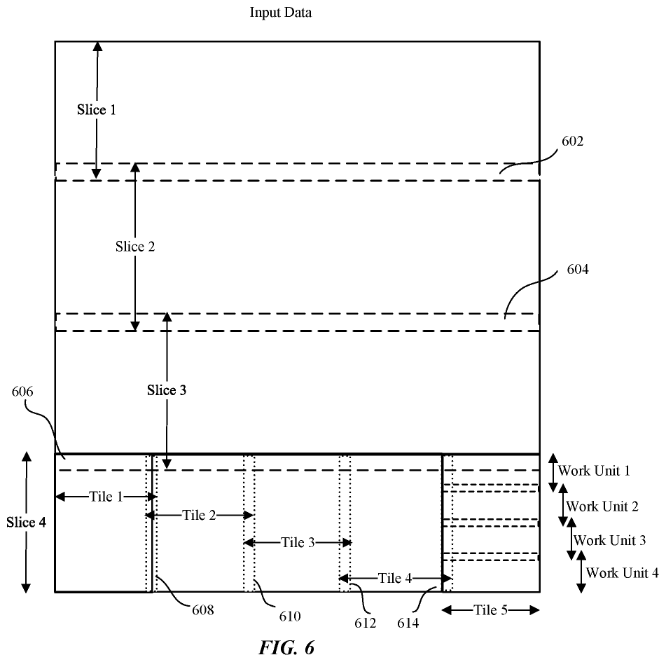

In the loop for each convolution group is a processing loop for a slice of the input data. The entire input data for a convolution operation is segmented into multiple strips of slices in an overlapping manner, as shown in FIG. 6. The overlapping portions 602, 604, 606 are parts of the input data that are overfetched in two adjacent slices to provide spatial support for a corresponding kernel. The second outermost loop performs convolution operation for each slice in the input data. Within the loop for a slice is a processing loop for a tile of the slice. Each tile is segmented into a plurality of tiles, as shown in FIG. 6. The overlapping portions 608, 610, 612, 614 are parts of the input data in slice 4 that are overfetched in two adjacent tiles to provide spatial support for a corresponding kernel. The rightmost tile will typically have a width smaller than other tiles of the slice. In one embodiment, input data for each tile is loaded onto data buffer 318 in a read cycle and reused for operations in processing loops for the tile. In the processing loop for the tile is a processing loop for a work unit. Each slice is segmented into multiple work units as shown in FIG. 6. A work unit is a portion of the input data having a size that produces output values that fit into accumulator 414 of neural engine 314 during a single cycle of the computation core 416. Although the shape of each work unit is shown as a horizontal strip in FIG. 6, the shape of the work unit can be different depending on the shape and size of the tile. The work units also have overlapping parts that represent overfetched to provide support for a corresponding kernel. Especially, work units for the last tile of a slice may have a shape of a vertical strip if the tile is tall. In one or more embodiments, the size of each work unit is 256 bytes. In such embodiments, for example, work units can be shaped to one of 16×16, 32×8, 64×4, 128×2 or 256×1 dimension.

For each work unit, an internal processing loop may be provided for an output channel group (OCG). The number of output channels produced for a given work unit by a single cycle of the computation core 416 is referred to as an OCG. Depending on operation modes, each neural engine 314 may process output data of different numbers of output channels (e.g., 8 channels, 32 channels) for a single load of input data into its input buffer circuit 402.

For each output channel group, an internal processing loop may be provided for an input channel (Cin). If an input stride is implemented to skip certain input data, loops for sub-input channels (Sub-Cin) may be provided within the processing loop for the input channel (Cin).

For each input channel or each sub-input channel, internal loops are provided for processing horizontal spatial support for a kernel and the vertical support within each horizontal spatial support. The spatial support refers to the input data for convolution with the kernel, and includes overfetched input data for performing convolution at the edges of the input data.

Overfetch refers to fetching additional input data in current slice, tile or work unit so that proper dimension of input data can be provided for convolution with a kernel. In one or more embodiments, overfetch is performed vertically between slices to obtain additional rows of input data (shown as overlapping portions 602, 604, 606 in FIG. 6), horizontally between tiles to obtain additional columns of input data (shown as overlapping portions 608, 606, 612, 614 in FIG. 6), and vertically between work units within a tile to obtain additional rows of input data.

For each spatial support for the kernel, an internal processing loop for an output channel (OC) is provided to generate output data for each output channel (Cout). In cases where output stride implements a spatial upsampling, an additional inner loop for processing each sub-output channel is provided. Loading of kernel coefficients and MAC operations are performed within the loop for the output channel (OC) or sub-output channel if an output stride is implemented, to generate output data for the output channel (OC) or sub-output channel.

The nested loop structure of FIG. 5 is merely illustrative. Loops may be omitted, added or structured differently depending on various factors. For example, if only a single convolution group is used, the outermost loop may be removed. Further, the loop structure for the horizontal spatial support and the vertical spatial support may be reversed.

In one or more embodiments, the operations associated dividing the input space into smaller units and processing these smaller units as described above with reference to FIGS. 5 and 6 are performed by rasterizers 714, 718, 720, 722 in various components of neural processor circuit 218. A rasterizer is a circuit in various components of neural processor circuit 218 that keeps track of the segment of the input/output data (e.g., group, work unit, input channel, output channel) and instructs the components of neural processor circuit for proper handling of the segment of the input data. For example, rasterizer 720 in buffer DMA 320 tracks tiles and slices received from system memory 230 while rasterizer 718 in data buffer 318 broadcasts in sequence work units for processing by the neural engines 314. Rasterizer 724 in kernel DMA 324 determines which kernels are to be received and distributed to neural engines 314, while rasterizers 714 in neural engines 314 operate shifters 410 in input buffer circuits 402 to forward correct portions 408 of input data to MAC 404, and send the finished output data 328 to the data buffer 318.

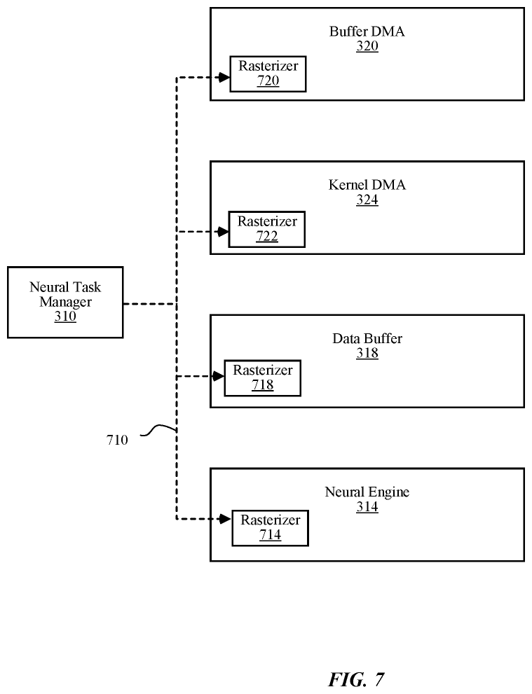

FIG. 7 is a diagram illustrating programming of rasterizers 714, 718, 720, 722 in components 314, 318, 320, 322 of the neural processor circuit 218, according to one embodiment. To perform their functions, each of rasterizers 714, 718, 720, 722 receives task information 710 indicating how the input data and/or kernel data are to be segmented and to be handled by each component of the neural processor circuit 218. The task information includes information about particulars of the current layer (e.g., dimensions of input and output data, dimension of an associated kernel, types of padding at the boundaries of input data). Rasterizers 714, 718, 720, 722 may also receive constraints on their operations (e.g., whether to allow or disallow tile width over a threshold).

By providing rasterizers in different components of neural processor circuit 218, overhead in data transmitted between the components of the neural processor circuit 218 may be reduced. If a single central rasterizer is provided to control different components of the neural processor circuit 218, kernel data, input data, and output data transmitted between the components may be needed in these data to identify associated position in the loops of the task such as convolution group, tile, slice, work unit, input channel and output channel. By using distributed rasterizers, no separate metadata is needed to transmit the kernel data, input data and output data among components of the neural processor circuit 218.

### Example Process at Neural Engine Architecture

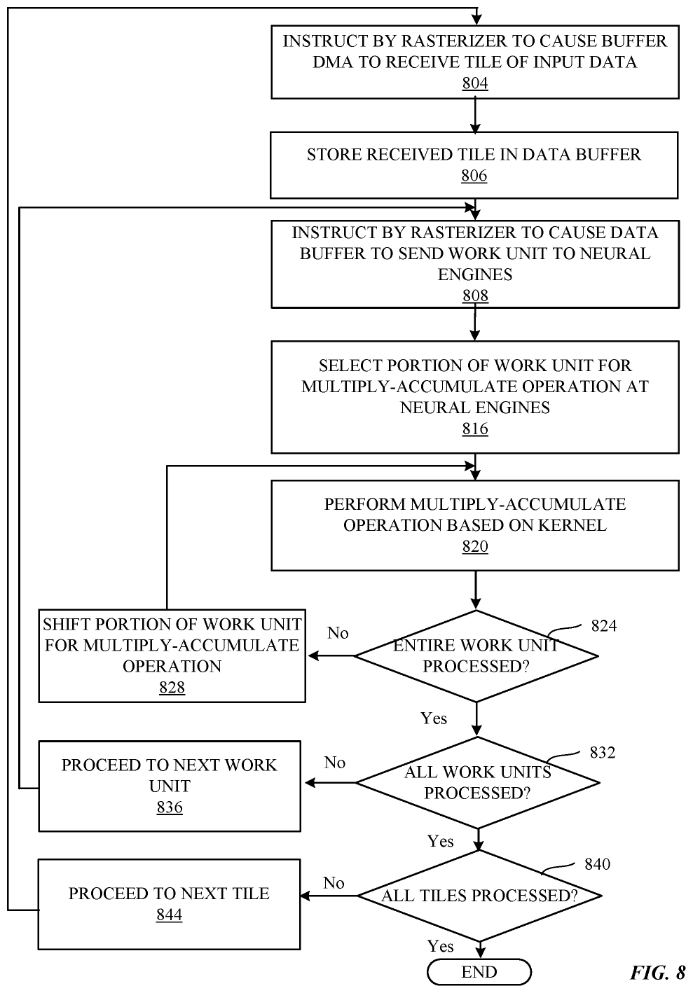

FIG. 8 is a flowchart illustrating a method of processing input data in neural processor circuit 218, according to one embodiment. After neural task manager 310 programs rasterizers 714, 718, 720, 722, the process of operating buffer DMA 320 is initiated by rasterizer 720 instructing 804 buffer DMA 320 to cause buffer DMA 320 to receive a tile of input data from system memory 230. The tile received by buffer DMA 320 is stored 806 in data buffer 318.

Rasterizer 718 in data buffer 318 then instructs 808 data buffer 318 to send a work unit to one or more neural engines 314. The work unit is then stored in input buffer circuits 402 of the one or more neural engines 314.

In one or more embodiments, input buffer circuit 402 selects 816 a portion of work unit to be sent to MAC 404 to perform multiply-accumulate operation. Then MAC 404 performs 820 multiply-accumulate operations on the selected portion of the work unit using a corresponding kernel. Then it is determined 824 if the entire work unit is processed at one or more neural engines 314. If not, the selected portion of the work unit is shifted by shifter 410 and returns to perform 820 another round of multiply-accumulate operations.

If it is determined 824 that the entire work unit was processed, then it proceeds to determine 832 if all work units in the tile was processed. If not, then the process proceeds 836 to the next work unit by having data buffer 318 send 808 a next work unit to one or more neural engines 314, and repeats the subsequent processes.

If it is determined 832 that all work units in the tile was processed by the neural engines 314, the process proceeds to determine 840 whether all tiles for the input data were processed. If not, the process proceeds 844 to a next tile by having rasterizer 720 instructs 804 buffer DMA 320 to receive a next tile from system memory 230 and repeats the subsequent processes.

If it is determined 840 that all tiles of the input data are processed, then the process ends for the current input data. Then, the process may repeated to process the next input data or proceed to the next task.

Embodiments of the process as described above with reference to FIG. 8 are merely illustrative. Further loops may be embodied, as described above with reference to FIG. 5. Moreover, sequence of the process may be modified or omitted.

### Input Stride Reduction

Convolution operations with input stride can be used to reduce spatial dimensions of input data 322 by skipping samples of input data 322 in horizontal and/or vertical directions. The input stride allows a convolution operation to skip samples of input data 322, reducing a resolution of output data 328 compared to input data 322.

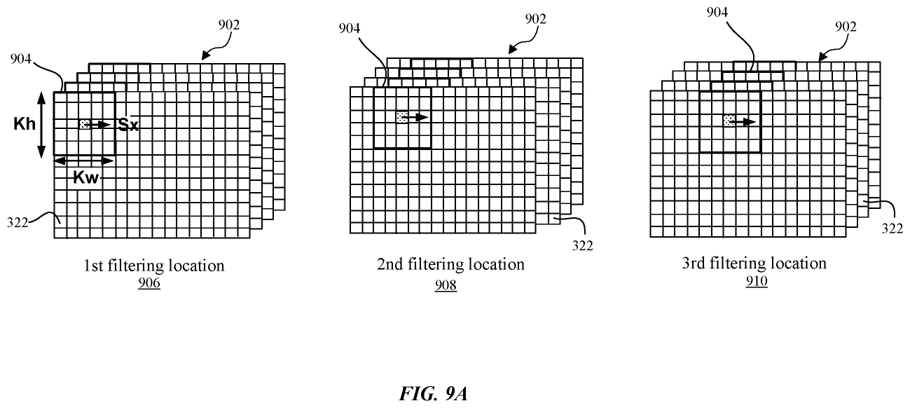

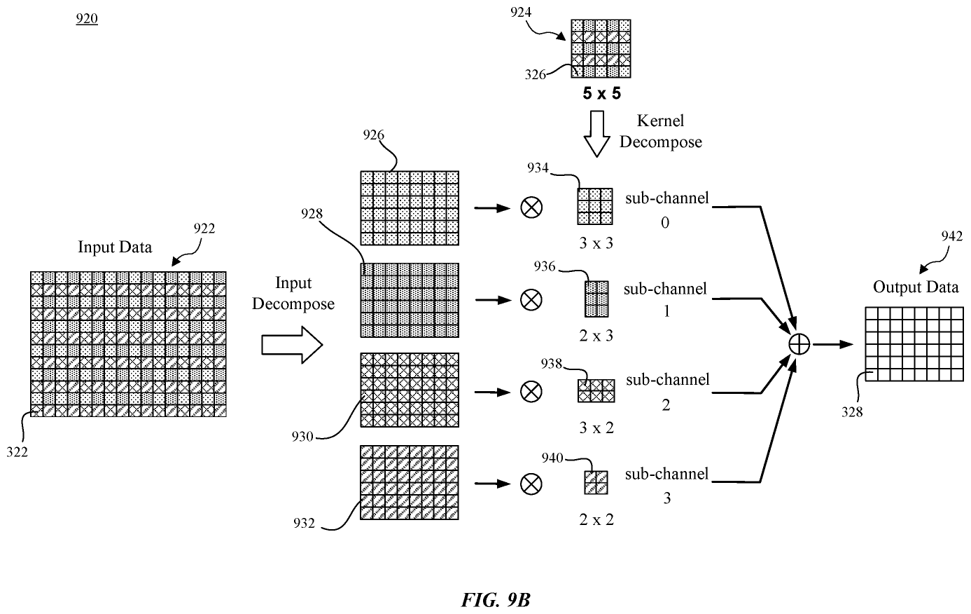

FIG. 9A is a conceptual diagram 900 illustrating the convolution operation between input data 902 (e.g., portion of input data 322) and kernel data 904 (e.g., kernel data 326) with input stride, according to one embodiment. The neural processor circuit 218 may be configured to perform convolution operation between multiple channels of input data 902 and kernel data 904 having spatial support of a kernel width (Kw)×a kernel height (Kh). FIG. 9A shows examples of filtering locations 906, 908, 910 when horizontal stride of two is applied, i.e., the factor Sx defining a step size along horizontal direction between different filtering locations is equal to two. A stride factor for each spatial direction, i.e., the factor Sx defining a subsampling ratio in horizontal direction and the factor Sy defining a subsampling ratio in vertical direction can be configured independently in the neural processor circuit 218.

FIG. 9B is a conceptual diagram 920 illustrating example convolution between input data 922 (e.g., portion of input data 322) and kernel data 924 (e.g., kernel data 326) having spatial support of 5×5 with input stride reduction, according to one embodiment. FIG. 9B shows how conceptually the neural processor circuit 218 implements convolution with input stride reduction when Sx=Sy=2. The input data 922 may be decomposed into four sub-channels 926, 928, 930, 932, wherein each sub-channel 926, 928, 930, 932 corresponds to a specific phase. Data buffer 318 may separately broadcast each sub-channel 926, 928, 930, 932 to input buffer circuits 402 of at least one of the neural engines 314. Neural engine 314 may receive 5×5 shaped kernel data 326 from kernel DMA 324, e.g., at kernel extract circuit 432.

The 5×5 shaped kernel data 326 (kernel data 924) may be decomposed offline (e.g., by compiler) into sub-kernels 934, 936, 938, 940 of smaller spatial support than that of the original 5×5 kernel data 326. The swizzled 5×5 shaped kernel data 326 may be stored in kernel extract circuit 432 in the post-swizzled order, e.g., kernel coefficients for sub-channel 0 associated with sub-kernel 934 are stored first in kernel extract circuit 432, followed by kernel coefficients for sub-channel 1 associated with sub-kernel 936, etc. The at least one neural engine 314 convolves each sub-channel 926, 928, 930, 932 and kernel coefficients from a corresponding sub-kernel 934, 936, 938, 940, as shown in FIG. 9B. Referring back to FIG. 4, each sub-channel 926, 928, 930, 932 corresponds to portion 408 of input data provided to MAC 404, and kernel coefficients of the corresponding sub-kernel 934, 936, 938, 940 correspond to kernel coefficients 422 provided to MAC 404. Then, processed values 412 generated by each sub-channel convolution are accumulated by accumulators 414 to generate (after pre-processing in post-processor 428) processed values 417 and output data 328 (e.g., output data 942 of FIG. 9B) of a quarter size compared to a size of portion of the input data 322 broadcast to the neural processor circuit 218 (e.g., input data 922).

As discussed, the input stride allows convolution to skip samples of portion of input data 322, thereby reducing the resolution of output data 328 compared to that of portion of input data 322. Kernel data 326 may be applied at the input resolution, and the effect would be as if kernel data 326 was applied to all samples of portion of input data 322, and then output data 328 was subsampled. If convolution with input stride reduction was implemented in this manner, the intermediate result would be wasted and 2×2 input stride would only utilize approximately 25% of MAC resources at each neural engine 314, e.g., MAD circuits MADO through MADN in MAC 404. Instead of running convolution at the input resolution and discarding convolution results to obtain the output resolution, the at least one neural engine 314 may perform convolution at the output resolution, by overfetching portion of input data 322 and performing a sub-channel swizzle to convert additional information into sub-channels.

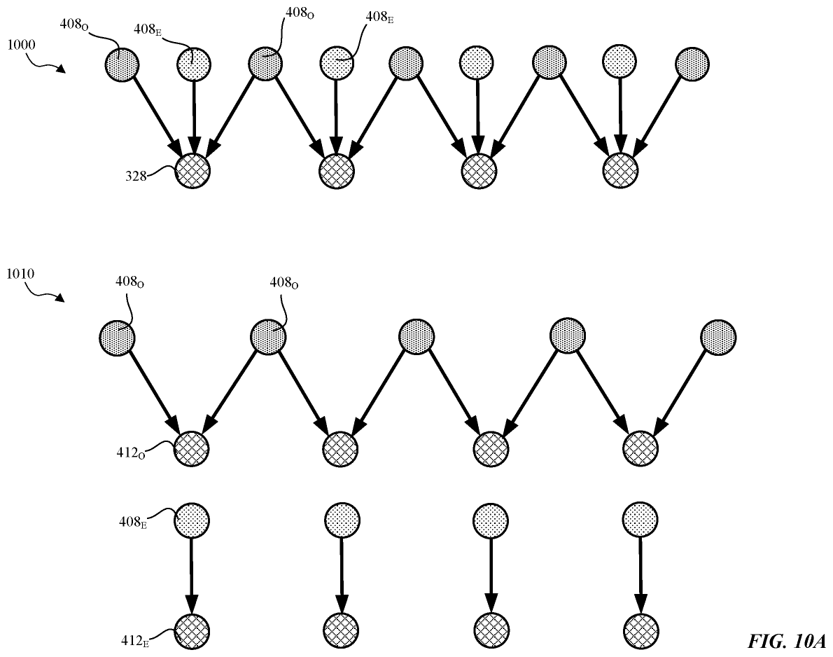

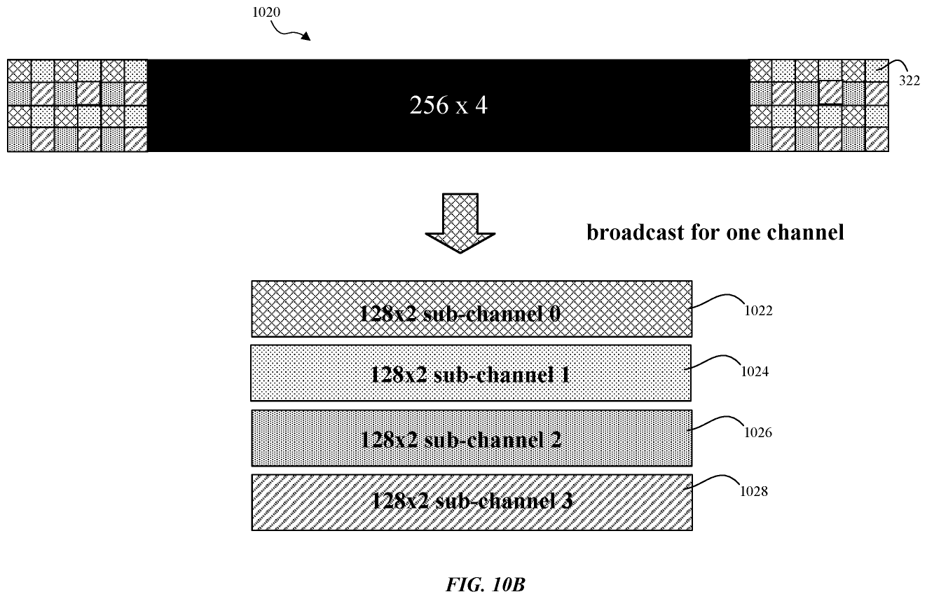

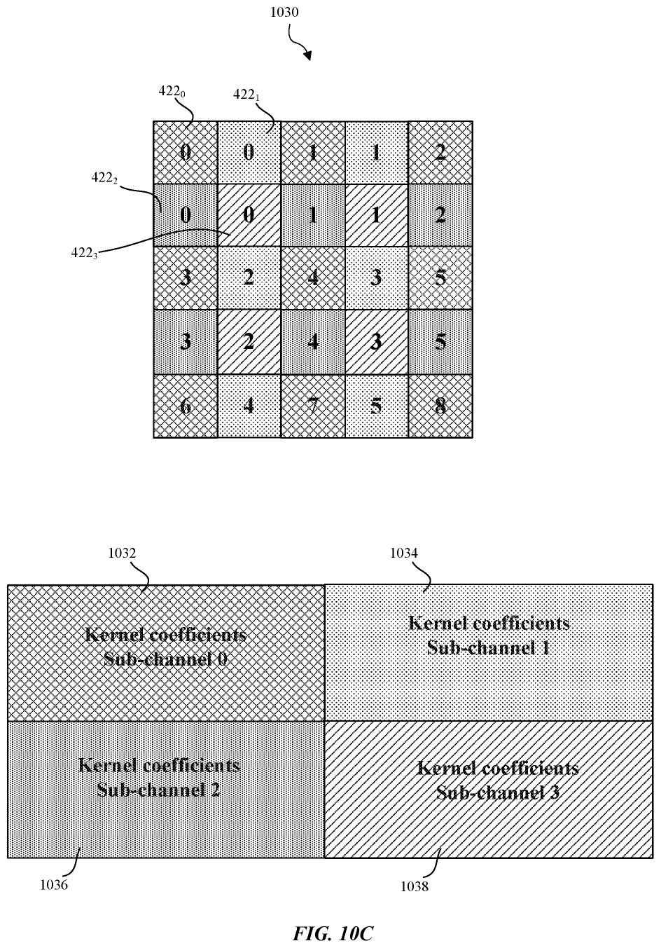

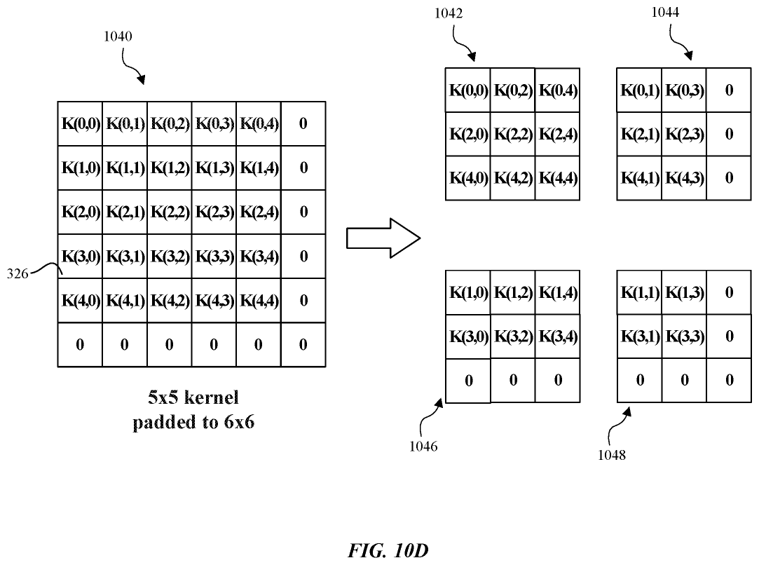

The algorithm for performing sub-channel swizzle is illustrated in FIG. 10A for the horizontal stride parameter Sx=2, producing two sub-channels of processed values 412 from a double-width portion of input data 322. The same algorithm can be used for input stride in vertical dimension (e.g., for Sy=2). In the case of Sx=Sy=2, a region of input data 322 may be fetched from the data buffer 318 that is four times as large, and four sub-channels can be produced in the shape of output work unit. FIG. 10A illustrates an example of sub-channel swizzle for convolution with input stride reduction where subsampling of two is used in horizontal direction, according to one embodiment. For kernel data 326 having spatial width of three (i.e., Kw=3) and for the subsampling parameter in horizontal direction of two (i.e., Sx=2), the convolution shown in diagram 1000 in FIG. 10A can be represented as two summed sub-channel convolutions, as shown in diagram 1010 in FIG. 10A. At least one neural engine 314 may be configured to perform sub-channel convolution on odd source pixels (i.e., odd values of portion 4080 of input data) and kernel data 326 having spatial width of two (i.e., two kernel coefficients 422), resulting into an odd sub-channel of processed values 412_{O}. The at least one neural engine circuit 314 may be further configured to perform sub-channel convolution on even source pixels (i.e., even values of portion 408_{E} of input data) and kernel data 326 having spatial width of one (i.e., one kernel coefficient 422), which results into an even sub-channel of processed values 412_{E}. The odd and even sub-channels of processed values 412_{O} and 412_{E} may be then accumulated by accumulators 414 to generate a single channel of processed values 412 and a single channel of output data 328 (after pre-processing in post-processor 428) for storage into the data buffer 318.

FIG. 10B illustrates an example of broadcasting portion 1020 of input data 322 from data buffer 318 to neural processor circuit 218 as multiple sub-channels for convolution with input stride reduction, according to one embodiment. In the illustrative embodiment of FIG. 10B, portion 1020 of input data 322 having a spatial support of, e.g., 256×4, may be stored in data buffer 318. Data buffer 318 may fetch a double-width region (i.e., portion 1020) of input data 322 from system memory 230. Data buffer 318 may be configured to perform transformation of portion 1020 of input data 322 into sub-channels 1022, 1024, 1026, 1028 at broadcast time. Data buffer 318 may de-interleave pixels of portion 1020 of input data 322 to present the pixels to neural engines 314 as sub-channels 1022, 1024, 1026, 1028. FIG. 10B shows the illustrative embodiment where 256×4 sized portion 1020 of input data 322 is de-interleaved at broadcast time into four 128×2 shaped sub-channels 1022, 1024, 1026, 1028. Data buffer 318 broadcasts each sub-channel 1022, 1024, 1026, 1028 to input buffer circuits 402 of the one or more neural engines 314.

Each neural engine 314 may be configured to stride through kernel data 326 stored in kernel extract circuit 432 stepping by, e.g., sub-sampling factors Sx and Sy, starting with a phase offset of a sub-channel of portion 408 of input data. In the illustrative embodiment shown in FIG. 10A, each neural engine 314 may utilize kernel coefficients 422 extracted from kernel extract circuit 432 having indexes 0 and 2 for a first sub-channel convolution with portion 408 of input data corresponding to odd pixels (i.e., portion 408_{O} corresponding to a first sub-channel). Each neural engine 314 may further utilize kernel coefficients 422 extracted from kernel extract circuit 432 having index 1 for a second sub-channel convolution with portion 408 of input data corresponding to odd pixels (portion 408_{E} corresponding to a second sub-channel). Kernel data 326 may be de-interleaved (e.g., within kernel extract circuit 432) in the same manner as portion of input data 322 is broadcast from data buffer 318 as corresponding sub-channels, as shown in FIG. 10B. In this way, per-sub-channel kernels of different sizes can be generated at each neural engine 314. For example, 5×5 shaped kernel data 326 may be sub-sampled (e.g., at kernel extract circuit 432) into sub-kernels of sizes 3×3, 2×3, 3×2 and 2×2, and provided as corresponding kernel coefficients 422 to MAC 404 for sub-channel convolutions with corresponding sub-channels of portion 408 of input data.

FIG. 10C illustrates arranging of 5×5 shaped kernel 1030 into sub-kernels having swizzled order for convolution with input stride reduction, according to one embodiment. The neural engine circuit 314 may receive kernel 1030 as kernel data 326 that is stored in kernel extract circuit 432. Kernel data 326 (kernel 1030) may be arranged so that kernel coefficients 422 are extracted from kernel extract circuit 432 in swizzled order. Kernel coefficients 422₀ of kernel data 326 may be extracted from kernel extract circuit 432 as sub-kernel 1032 corresponding to sub-channel 0 for sub-channel convolution with sub-channel 1022 of input data. Kernel coefficients 422₁ of kernel data 326 may be extracted from kernel extract circuit 432 as sub-kernel 1034 corresponding to sub-channel 1 for sub-channel convolution with sub-channel 1024 of input data. Kernel coefficients 422₂ of kernel data 326 may be extracted from kernel extract circuit 432 as sub-kernel 1036 corresponding to sub-channel 2 for sub-channel convolution with sub-channel 1026 of input data. Kernel coefficients 422₃ of kernel data 326 may be extracted from kernel extract circuit 432 as sub-kernel 1038 corresponding to sub-channel 3 for sub-channel convolution with sub-channel 1028 of input data. Neural engine 314 loads a corresponding sub-channel of input data 322 from data buffer 318 into input buffer circuit 402, and the sub-channel of input data 322 is then provided as portion 408 of input data to MAC 404 for sub-channel convolution with corresponding sub-kernel coefficients 422. Neural engine 314 may compute a size of each sub-kernel based on information about a corresponding sub-channel, e.g., provided by NE control 418.

Data buffer 318 may overfetch portion of input data 322 from system memory 230 with phased overfetch. For example, a 16×16 portion of input data 322 for convolution with 1×5 shaped kernel data 326 with 1×2 stride (i.e., Sx=1 and Sy=2) can be overfetched by data buffer 318 as a 16×35 portion of input data 322 and de-interleaved into a first sub-channel of a 16×18 portion of input data 322 and a second sub-channel of a 16×17 portion of input data 322. The first sub-channel portion of input data 322 may be convolved with 1×3 shaped kernel data 326, and the second sub-channel portion of input data 322 may be convolved with 1×2 shaped kernel data 326.

When kernel data 326 is odd-sized and a convolution with input stride of two is performed, individual sub-channels of portion of input data 322 and sub-kernels extracted from kernel extract circuit 432 would have different sizes, which is not suitable for efficient execution of convolution at neural engine 314. In this case, kernel data 326 stored into kernel extract circuit 402 are padded with zeroes to obtain kernel data 326 having spatial shape of multiple of two in both spatial dimensions. For example, 5×5 shaped kernel data 326 for convolution with 2×2 input stride can be zero-padded to become 6×6 shaped kernel data 326 stored in kernel extract circuit 432. In an embodiment, NE control 418 may instruct zero-padding on 5×5 shaped kernel data 326 and configure neural engine 314 accordingly. If kernel data 326 uses compression (e.g., when being stored in kernel extract circuit 432), the padded zeroes may be skipped by neural engine 314 with limited performance loss. FIG. 10D illustrates an example of zero-padding applied on a kernel 1040 and splitting the zero-padded kernel 1040 into multiple sub-kernels 1042, 1044, 1046, 1048 for convolution with input stride reduction. In an embodiment, zero-padding may be applied on 5×5 shaped kernel data 326 (kernel 1040) to generate 6×6 shaped kernel data 326. The 6×6 shaped kernel data 326 may be split into four 3×3 shaped sub-kernels 1042, 1044, 1046, 1048 and extracted in appropriate order from kernel extract circuit 432 as kernel coefficients 422. Note that the zero-padding is not required for even-sized kernel data 326. In some embodiments, when zero-padding of odd-sized kernel data 326 is applied, padded zeroes may be skipped in other modes of neural engine 314 when neural engine 314 performs operations with operands associated with the padded zeroes. For example, when neural engine 314 performs average pooling after convolution based on kernel data 326 with padded zeroes, certain add operations can be skipped in MAC 404 since the operands are zeroes.

To perform convolution with input stride reduction, at least one of neural engines 314 is configured to receive multiple sub-channels of portion of input data 322 from data buffer 318. Each sub-channel may be stored into input buffer circuit 402 and provided to MAC 404 as portion 408 of input data. Kernel data 326 received from kernel DMA 324 (i.e., kernel fetcher circuit) and stored at kernel extract circuit 432 may correspond to a subsampled sub-kernel for each sub-channel of portion of input data 322. Neural engine 314 performs a convolution operation on each sub-channel of portion 408 of input data 322 and the corresponding sub-kernel (i.e., corresponding kernel coefficients 422 extracted from kernel extract circuit 432). Neural engine 314 accumulates, by accumulators 414, corresponding processed values 412 of each sub-channel portion of the convolution operation to generate a single channel of processed values 412 and a single channel of output data 328 for storage into data buffer 318. Data buffer 318 may de-interleave a channel of portion of input data 322 into the sub-channels of portion of input data 322 for broadcasting to input buffer circuit 402. Neural engine 314 may receive the sub-channels of portion of input data 322 from data buffer 318 over multiple processing cycles. In an embodiment, kernel data 326 stored into kernel extract circuit 432 includes padded zeroes, and a spatial size of kernel data 326 with padded zeroes is a multiple of two in each spatial dimension of kernel data 326.

### Output Stride Expansion

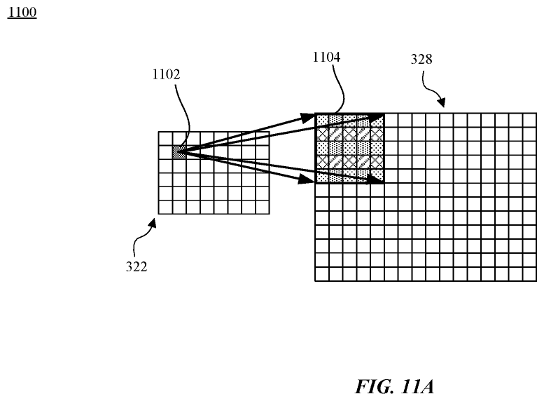

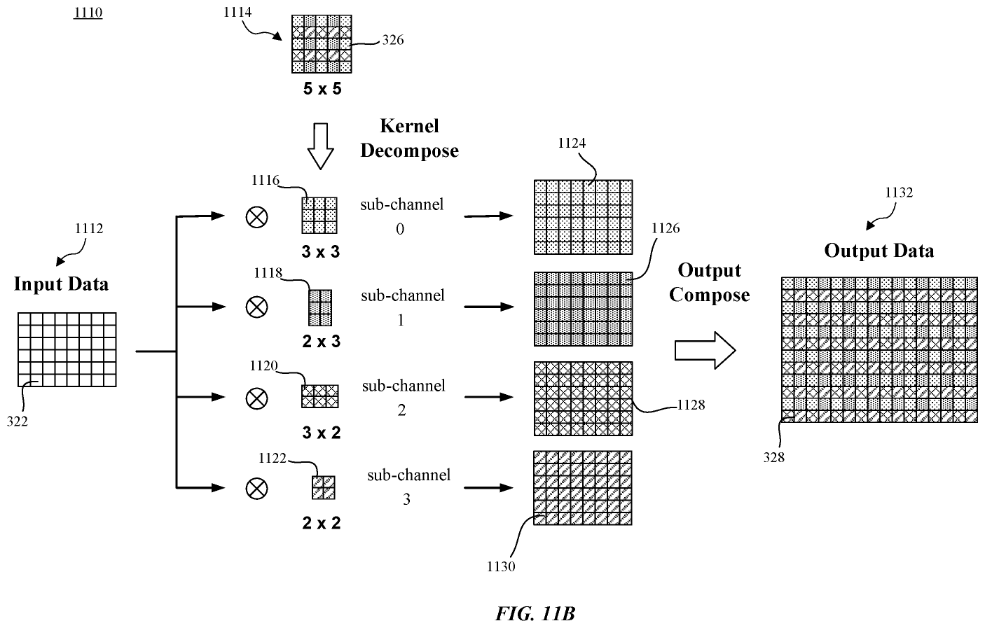

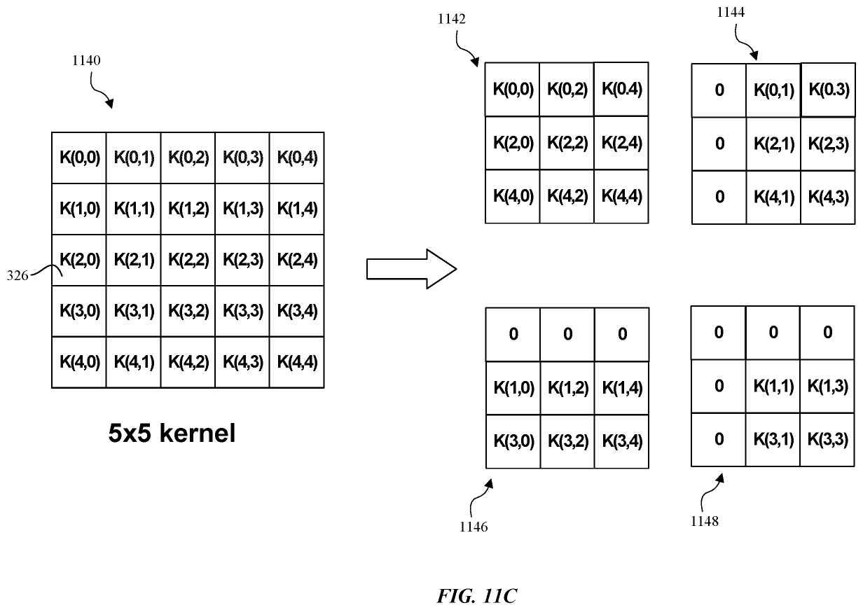

The inverse operation to the input stride reduction is output stride expansion. The output stride expansion can be used when running an input-strided convolution or average-pooled network layer backwards with a transposed kernel, which can be referred to herein as ‘transposed convolution’ representing an inverse operation of convolution. Transposed convolution can be utilized in the backpropagation pass of CNN when a convolution layer is trained. Transposed convolution can be useful in various applications, e.g., image style transfer, per-pixel image segmentation, etc. FIG. 11A illustrates an example transposed convolution 1100, where each input pixel 1102 in portion of input data 322 is spread over output kernel window 1104 (e.g., kernel data 326) into multiple output pixels of output data 328.

FIG. 11B is an example conceptual diagram 1110 illustrating transposed convolution with output stride expansion, according to one embodiment. FIG. 11B shows the illustrative embodiment of transposed convolution on portion 1112 of input data 322 and 5×5 shaped kernel 1114 (kernel data 326) with stride of two. The transposed convolution can be considered as upsampling of portion 1112 of input data 322 by a factor of two for generating output data 1132 (output data 328). At least one of the neural engines 314 may receive portion 1112 of input data 322 from data buffer 318 for storage into input buffer circuit 402. Portion 1112 of input data 322 may be provided to MAC 404 as portion 408 of input data. The at least one neural engine 314 may further receive, at kernel extract circuit 432, 5×5 shaped kernel 1114 from kernel DMA 324. Kernel 1114 may be decomposed (e.g., offline, by the compiler) into sub-kernels 1116, 1118, 1120, 1122 that are stored in appropriate order in kernel extract circuit 432. Each sub-kernel 1116, 1118, 1120, 1122 can be extracted from kernel extract circuit 432 as corresponding kernel coefficients 422 and provided to MAC 404. The at least one neural engine 314 performs convolution on kernel coefficients 422 from the corresponding sub-kernel 1116, 1118, 1120, 1122 and portion 1112 of input data 322 (portion 408 of input data). Convolved results 1124, 1126, 1128, 1130 generated as processed values 412 and stored in output circuit 424 after post-processing as processed values 417 can be combined based on a sub-channel phase of each processed value 417 to generate upsampled output data 1132, i.e., upsampled output data 328 for storage into data buffer 318.

Data buffer 318 and neural engines 314 support transpose convolution with output stride expansion by producing multiple sub-channels of processed values 412 from each input channel of portion of input data 322. The sub-channels of processed values 412 may be generated in different accumulators 414 in the at least one neural engine 314 using sub-kernels 1116, 1118, 1120, 1122 stored as subsampled kernel data 326 in kernel extract circuit 432. For example, in the case of 5×5 shaped kernel 1114 with output stride of two in both spatial dimensions, portion 1112 of input data 322 may be convolved with sub-kernels 1116, 1118, 1120, 1122 of size 3×3, 3×2, 2×3 and 2×2 into four different accumulators 414. At the end of convolution, four sub-channels of processed values 412 may be post-processed in post-processor 428, stored in output circuit 424 and written back to data buffer 318 as output data 328. Data buffer 318 may interleave the four sub-channels of output data 328 to produce output data 328 that is four times as large as portion 1112 of input data 322.

Similarly to the input stride mode, when using output stride expansion, kernel data 326 may be padded with zeroes to obtain zero-padded kernel data 326 having an even value for both spatial dimensions. For example, 5×5 shaped kernel data 326 used for 2×2 output stride expansion requires zero-padding into 6×6 shaped kernel data 326. The sparseness feature can efficiently skip the padded zeroes when compression is enabled.

FIG. 11C illustrates an example splitting of 5×5 shaped kernel 1140 (i.e., kernel data 326) into 3×3 shaped sub-kernels 1142, 1144, 1146, 1148. The 5×5 shaped kernel 1140 may be split into four 3×3 shaped sub-kernel 1142, 1144, 1146, 1148, which may be then extracted in corresponding order from kernel extract circuit 432 as kernel coefficients 422. Neural engine 314 (e.g., via NE control 418) may be configured to pad zeroes in proper positions within stored kernel data 326 to achieve correct functionality. Additionally, kernel coefficients 422 of zero-padded kernel data 326 may be linearized before being extracted from kernel extract circuit 432.

To perform convolution with output stride expansion, the at least one neural engine 314 can be configured to receive one or more channels of portion of input data 322 from data buffer 318. Each channel of portion of input data 322 may be stored in input buffer circuit 402 and provided to MAC 404 for convolution as portion 408 of input data. The at least one neural engine 314 may further receive kernel data 326 at kernel extract circuit 432 from kernel DMA 324 (kernel fetcher circuit), and split the received kernel data 326 into multiple sub-kernels. The sub-kernels can be extracted from kernel extract circuit 432 as kernel coefficients 422 and provided to MAC 404 for convolution. The at least one neural engine 314 may perform a convolution operation on portion 408 of input data and the corresponding kernel coefficients 422 (sub-kernels) to generate multiple sub-channels of processed values 412 for each channel of portion 408 of input data 322.

The multiple sub-channels of processed values 412 generated for each channel of portion of input data 322 may be post-processed in post-processor 428, stored as processed values 417 in output circuit 424, and output as output data 328 for storage into data buffer 318. Each sub-channel of processed values 412 may be generated using a different accumulator 414 in the at least one neural engine 314. The data buffer 318 may interleave the sub-channels of output data 328 to produce a channel of output data 328 having a spatial size in accordance with a spatial size of the received kernel data 326. Note that the spatial size of output data 328 is larger than that of the received channel of portion of input data 322. Note also that two or more of the sub-kernels generated by splitting the received kernel data 326 may comprise padded zeroes across at least one dimension of the two or more sub-kernels.

### Large Kernel Mode

Enabling both input stride reduction and output stride expansion provides support for effectively doubling a size of kernel. Note that, for both input stride reduction and output stride expansion, kernel data 326 received at kernel extract circuit 432 is being subsampled. Because of the kernel subsampling, a maximum kernel range is effectively doubled, which allows for utilizing kernels of sizes effectively doubled for both convolution and transposed convolution.

For example, to perform a convolution with 29×29 shaped kernel data 326 and obtain 16×16 shaped output data 328, at least one of the neural engines 314 (e.g., via NE control 418) may pad zeroes to kernel data 326 to effectively generate 30×30 shaped kernel data 326. Data buffer 318 may fetch 32×32 shaped portion of input data 322 from system memory 230 as overfetched 60×60 shaped portion of input data 322. Data buffer 318 may broadcast 60×60 shaped portion of input data 322 to neural processor circuit 218 as four sub-channels of 16×16 shaped portion of input data 322 overfetched to 30×30 shaped portion of input data 322. The at least one neural engine 314 may receive each 30×30 shaped portion of input data 322 (i.e., each source sub-channel) from data buffer 318 over multiple processing cycles as a sub-channel of portion of input data 322.

Inside neural engine 314, the 30×30 shaped kernel data 326 may be subsampled into 15×15 shaped kernels. Each 15×15 shaped kernel may be applied as corresponding kernel coefficients 422 to their respective sub-channels of portion of input data 322 (portions 408 of input data) and accumulated into their own accumulator 414. The four resulting 16×16 shaped sub-channels of processed values 412 may be post-processed and output as four sub-channels of output data 328 to data buffer 318. Data buffer 318 may re-interleave the four 16×16 shaped sub-channels into 32×32 shaped result. Note that odd-sized kernels (e.g., 15×15 shaped kernels) may be zero-padded (e.g., via NE control 418) to obtain even-sized kernels for extraction from kernel extract circuit 432 as kernel coefficients 432.

When operating in large kernel mode, kernel data 326 is replicated. For 1-dimensional (1D) shaped data, half-sized kernel data 326 may be used for each pair of input and output sub-channels. For example, even-even and odd-odd pairs of input-output sub-channels may use the same subsampled kernel including even coefficients 422 of original kernel data 326. The even-odd and odd-even pairs of input-output sub-channels may use spatially shifted kernels including odd coefficients 422 of original kernel data 326. In the case of spatial width of original kernel data 326 being odd, zero-padding may be applied on the left side for the odd-even sub-kernel and on the right side for the even-odd sub-kernel. For example, kernel data 326 having spatial width of five with coefficients [C0, C1, C2, C3, C4] may use coefficients [C0, C2, C4] for the even-even and odd-odd sub-kernels, coefficients [0, C1, C3] for the even-odd sub-kernel, and coefficients [C1, C3, 0] for the odd-even sub-kernel. The 2-dimensional (2D) versions of sub-kernels are direct extension of 1D version, producing 16 quarter-sized sub-kernels. Four of these 16 quarter-sized sub-kernels comprise even kernel coefficients 422 and the other 12 sub-kernels comprise odd kernel coefficients 422 padded on different sides by zeroes.

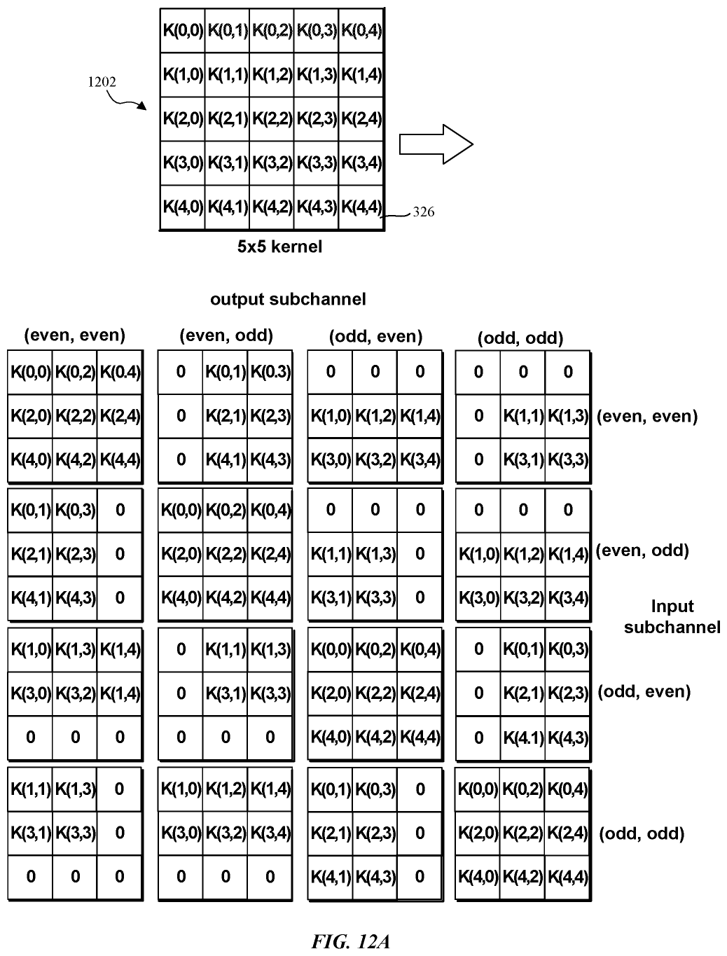

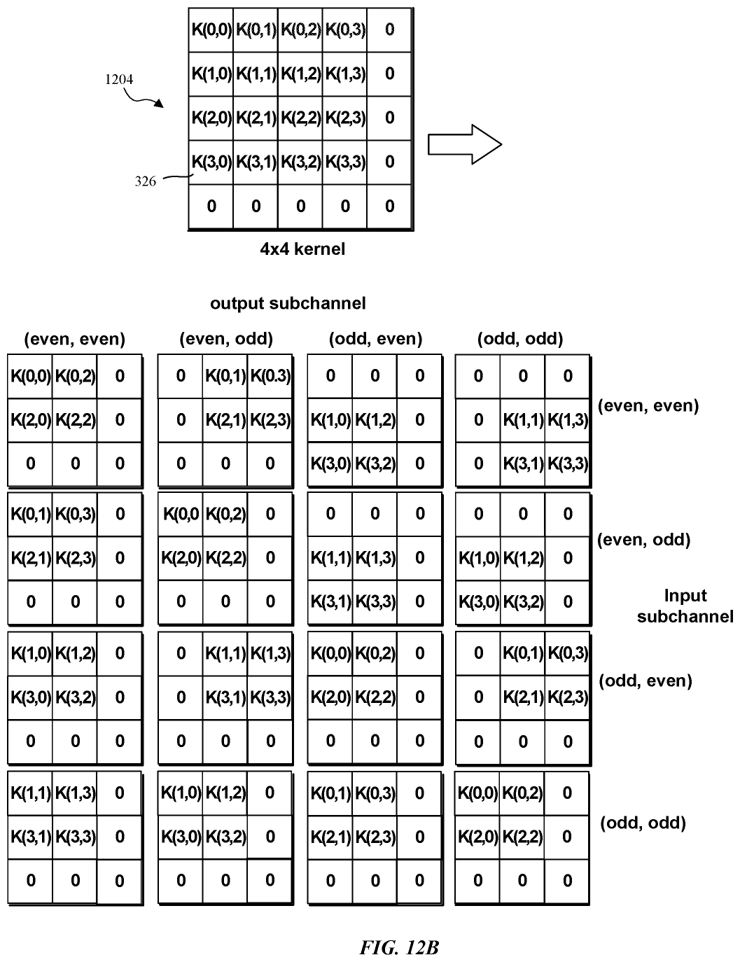

FIG. 12A illustrates an example of splitting 5×5 shaped kernel 1202 (kernel data 326) into sixteen 3×3 sub-kernels, one sub-kernel for each input-output sub-channel pair. The 5×5 shaped kernel 1202 may be split into sixteen 3×3 sub-kernels, and then neural engine 314 may linearize kernel coefficients 422 from the sub-kernels before being provided to MAC 404 for convolution. Neural engine 314 (e.g., via NE control 418) may also pad zeroes in proper positions within the sub-kernels to achieve correct functionality as the corresponding kernel coefficients 422 are extracted from kernel extract circuit 432 and convolved with a sub-channel portion 408 of input data.

FIG. 12B illustrates an example of splitting 4×4 shaped kernel data 326 into sixteen 3×3 sub-kernels, one sub-kernel for each input-output sub-channel pair. Zeroes may be padded on certain positions of kernel data 326 to obtain zero-padded 5×5 shaped kernel 1204 (kernel data 326). Neural engine 314 may split 5×5 shaped kernel 1204 and repeat portions of the kernel 1204 into sixteen 3×3 sub-kernels, and then linearize kernel coefficients 422 from the sub-kernels before being provided to MAC 404 for convolution. Neural engine 314 (e.g., via NE control 418) may also pad zeroes in proper positions within the sub-kernels to achieve correct functionality as corresponding kernel coefficients 422 are extracted from the kernel extract circuit 432 and convolved with a sub-channel portion 408 of input data. Note that the two illustrative embodiments provided in FIGS. 12A-12B show kernels for 4×4 and 5×5 convolutions, which are not necessarily convolutions performed using large kernel mode presented herein. The embodiments of FIGS. 12A-12B are only illustrative to show zero-padding and sub-sampling into sub-kernels for both odd-sized and even-sized kernels. The illustrative embodiments shown in FIGS. 12A-12B can be extended to large size kernels having spatial height and width larger than predefined values.

To perform convolution in accordance with the large kernel mode, the at least one neural engine 314 is configured to receive multiple sub-channels of portion of input data 322 from data buffer 318. Each sub-channel of portion of input data 322 may be stored in input buffer circuit 402 and provided to MAC 404 for convolution as a sub-channel of portion 408 of input data. Neural engine 314 further generates multiple sub-kernels using a kernel received from the kernel DMA 324 at kernel extract circuit 432. The generated sub-kernels are extracted as corresponding kernel coefficients 422 and provided to MAC 404. The at least one neural engine 314 may perform convolution on each sub-channel of portion 408 of input data 322 and kernel coefficients 422 of corresponding sub-kernels to generate multiple sub-channels of processed values 412 for each sub-channel of portion 408 of input data. For each sub-channel of portion 408 of input data, the sub-channels of processed values 412 are post-processed in post-processor 428, stored in output circuit 424 as processed values 417, and output as output data 328 for storage in data buffer 318. Data buffer 318 may interleave the sub-channels of output data 328 for each sub-channel of portion 408 of input data to produce a channel of output data 328 stored in data buffer 318. Each sub-channel of processed values 412 may be generated using a different accumulator 414 in the at least one neural engine 314. Furthermore, the sub-kernels stored in kernel extract circuit 432 may comprise a subset of repeated sub-kernels, and two or more of the sub-kernels may comprise padded zeroes across at least one dimension.

### Small Source Mode

For sizes of portions of input data 322 being less than a full work unit, the neural engines 314 are unable to utilize a high level of MAC capacity. CNN may use small patches of input data 322 in their terminal segments, e.g., patches of input data 322 having 8×8 spatial size. The patches of input data 322 of spatial size 8×8 would cause neural engines 314 to operate at approximately 25% efficiency. In order to increase utilization efficiency, neural engines 314 presented herein support a work unit having a spatial size of 8×8, which pairs up four MAD circuits and accumulators 414 in MAC 404 to produce four simultaneous output channels of processed values 412 and output data 328. The spatial size of work unit may be the same for both 8-bit integer precision and 16-bit floating point precision. Thus, at least one of the neural engines 314 may produce four 8×8 channels of output data 328 using 8×8 patch of input data 322.

In regular operational mode, computation core 416 in the neural engine 314 may process up to eight channels per broadcast from data buffer 318, which depends on a number of output accumulators 414 per each computation core 416. Each computation core 416 may also produce eight output channels per each broadcast of portion of input data 322 from data buffer 318. In contrast, in the small source mode (e.g., when portion of input data 322 is broadcast as 8×8 patch of input data), each computation core 416 may process four small output channels by feeding computation core 416 with four different kernel coefficients 422 for convolution with up to 64 input values of portion 408 of input data. Therefore, for the small source mode and 8-bit integer precision or 16-bit floating point precision, each computation core 416 may support up to 32 output channels of output data 328 per broadcast of portion of input data 322 from data buffer 318. A restriction on a spatial size of kernel data 326 received at the kernel extract circuit 432 may be imposed, e.g., the spatial width of kernel data 326 may be less than or equal to eight. It should be also noted that accumulators 414 may be configured to perform accumulation operations on 32-bit integer operands, i.e., accumulated processed values 412 may be 32-bit integers.

The small source mode can be utilized when the entire output surface of the output data 328 is of shape 8×8 or smaller, which cannot be used as a normal shape size during regular convolution of larger images. Also, the small source mode consumes four times as many kernel coefficients 422 per processing cycle, which increases a kernel bandwidth. While the aforementioned 16-bit floating point mode for portion of input data 322 similarly increases kernel bandwidth (e.g., by two times, because two channels of output data 328 may be generated per processing cycle), the 16-bit floating point mode of portion of input data 322 may reuse kernel coefficients 422 for every work unit of a large output surface of output data 328, reducing average kernel bandwidth. By necessity, 8×8 patches of portion of input data 322 will incur no re-use (i.e., 8×8 patches are single work unit surfaces), making the sustained kernel bandwidth very large for a series of small-patch layers of input data 322.

For performing convolution on small sources of portion of input data 322, neural engine 314 is configured to receive one or more patches of portion of input data 322 from data buffer 318 over a processing cycle. Neural engine 314 may further receive, from kernel DMA 324 at kernel extract circuit 432 during the processing cycle, kernel data 326 having multiple kernels. Neural engine 314 may perform convolution operations on each of the one or more patches of portion of input data 322 and the kernels extracted from kernel extract circuit 432 as corresponding kernel coefficients, producing multiple output channels of output data 328. Neural engine 314 may perform multiply-accumulate operations on one of the one or more patches of portion of input data 322 and two or more of the kernels producing multiple output channels of processed values 412 in accumulators 414.

### Example Processes at Neural Engine Architecture for Different Operational Modes

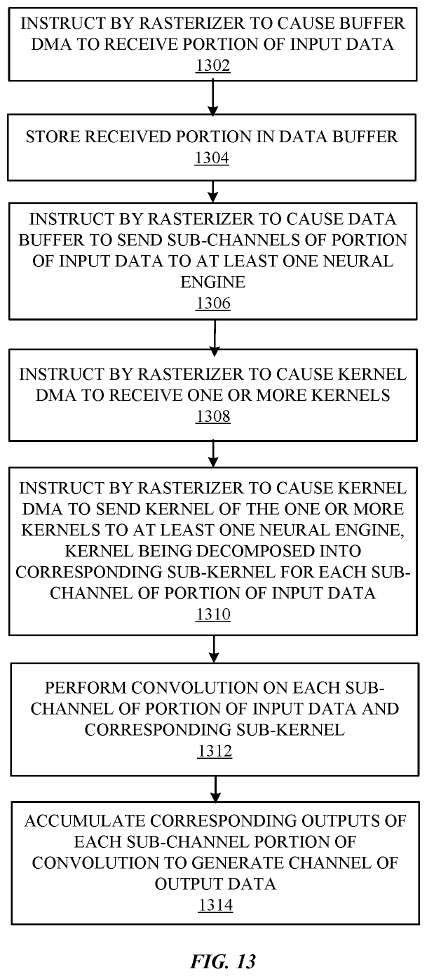

FIG. 13 is a flowchart illustrating a method of convolution with input stride reduction performed by neural processor circuit 218, according to one embodiment. After neural task manager 310 programs rasterizers 714, 718, 720, 722, the process of operating buffer DMA 320 is initiated by rasterizer 720 instructing 1302 buffer DMA 320 (i.e., data reader) to cause buffer DMA 320 to receive at least a portion of input data from system memory 230. The portion of input data received by buffer DMA 320 is stored 1304 in data buffer 318. The portion of the input data includes a work unit of the input data.

Rasterizer 718 in data buffer 318 then instructs 1306 data buffer 318 to send multiple sub-channels of the portion of the input data to at least one of the neural engines 314. The work unit of input data (e.g., at least a portion of sub-channel of input data) is then stored in input buffer circuit 402 of the at least one neural engine 314. Rasterizer 718 in data buffer 318 instructs data buffer 318 to de-interleave a channel of the portion of the input data into the sub-channels of the portion of the input data. Rasterizer 718 in data buffer 318 instructs data buffer 318 to send to the at last one neural engine 314 the sub-channels of the portion of the input data over multiple processing cycles.

Rasterizer 722 in kernel DMA 324 (kernel fetcher circuit) then instructs 1308 kernel DMA 324 to receive one or more kernels from system memory 230. Rasterizer 722 in kernel DMA 324 then instructs 1310 kernel DMA 324 to send a kernel of the one or more kernels to the at least one neural engine circuit 314. The kernel may be stored as kernel data 326 in the kernel extract circuit 432. Kernel data 326 may be decomposed (e.g., offline, prior to reception by neural engine 314 at kernel extract circuit 432) into a corresponding sub-kernel for each sub-channel of the portion of the input data.

The at least one neural engine 314 then performs 1314 a convolution operation on each sub-channel of the portion of the input data and the corresponding sub-kernel. The at least one neural engine 314 then accumulates 1316 corresponding outputs of each sub-channel portion of the convolution operation to generate a single channel of output data 328.

Rasterizer 718 in data buffer 318 may instruct data buffer 318 to send one or more channels of the portion of the input data to the at least one neural engine 314. A work unit of the one or more channels may be stored in input buffer circuits 402 of the one or more neural engines 314. Rasterizer 722 in kernel DMA 324 may also instruct kernel DMA 324 to send another kernel of the one or more kernels to the at least one neural engine 314. The other kernel may be stored as kernel data 326 in kernel extract circuit 432. Kernel data 326 may be decomposed (e.g., offline, prior to reception by neural engine 314 at kernel extract circuit 432) into multiple sub-kernels for extraction in corresponding sub-channel order as kernel coefficients 422. The at least one neural engine 314 performs another convolution operation on the one or more channels of the portion of input data and the sub-kernels to generate multiple sub-channel output data 328 for each channel of the portion of the input data. The sub-channel output data 328 for each channel of the portion of the input data are stored in data buffer 318. Rasterizer 718 in data buffer 318 may instruct data buffer 318 to interleave the sub-channel outputs for each channel of the portion of the input data to produce a channel output having a size in accordance with a size of the other kernel.

Rasterizer 718 in data buffer 318 may instruct data buffer 318 to send another set of sub-channels of the portion of the input data to the at least one neural engine 314. A work unit of the sub-channels may be stored in input buffer circuits 402 of the one or more neural engines 314. Rasterizer 722 in kernel DMA 324 may also instruct kernel DMA 324 to send another kernel of the one or more kernels to the at least one neural engine 314. The other kernel may be stored as kernel data 326 in kernel extract circuit 432. Kernel data 326 may be decomposed (e.g., offline, prior to reception by neural engine 314 at kernel extract circuit 432) into multiple sub-kernels for extraction in corresponding sub-channel order as kernel coefficients 422. The at least one neural engine 314 performs another convolution operation on each sub-channel of the other set of sub-channels of the portion of the input data and the sub-kernels to generate multiple sub-channel output data 328 for each sub-channel of the portion of the input data. The sub-channel output data 328 for each sub-channel of the portion of the input data are stored in data buffer 318. Rasterizer 718 in data buffer 318 may instruct data buffer 318 to interleave the sub-channel outputs for each sub-channel of the portion of the input data to produce output data.

Rasterizer 718 in data buffer 318 may instruct data buffer 318 to send one or more patches of the portion of the input data to the at least one neural engine 314 over a processing cycle. The one or more patches of the portion of the input data may be stored in input buffer circuits 402 of the one or more neural engines 314. Rasterizer 722 in kernel DMA 324 may also instruct kernel DMA 324 to send multiple kernels to the least one neural engine 314 over the processing cycle. The kernels may be stored as kernel data 326 in the kernel extract circuit 432. The at least one neural engine 314 performs convolution operations on each of the one or more patches of the portion of the input data and the kernels to produce multiple output channels of output data 328.

Embodiments of the process as described above with reference to FIG. 13 are merely illustrative. Further operations may be embodied, as described above with reference to FIGS. 9A-9B, FIGS. 10A-10D, FIGS. 11A-11C, and FIGS. 12A-12B. Moreover, sequence of the process may be modified or omitted.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

1. A neural processor circuit, comprising:
a neural engine circuit comprising an input buffer and an operation unit;
a data buffer;
a data reader comprising a first rasterizer circuit configured to cause the data reader to receive at least a first portion of input data from a system memory external to the neural processor circuit and to store the first portion of input data in the data buffer, wherein the data buffer comprises a second rasterizer circuit configured to cause the data buffer to send a second portion of input data selected from the first portion of input data to the neural engine circuit; and
a kernel fetcher circuit comprising a third rasterizer circuit configured to cause the kernel fetcher circuit to receive a kernel from the system memory and to send the kernel to the neural engine circuit, wherein the neural engine circuit comprises a fourth rasterizer circuit configured to store the second portion of input data in the input buffer of the neural engine circuit and to forward a third portion of input data selected from the second portion of input data to the operation unit of the neural engine circuit for processing to generate output data based on the third portion of input data and the kernel.

2. The neural processor circuit of claim 1, wherein the second portion of input data is a part of the first portion of input data and the third portion of input data is a part of the second portion of input data.

3. The neural processor circuit of claim 1, wherein the first portion of input data comprises a tile of input data, the second portion of input data comprises a work unit of the tile of input data, and the third portion of input data is a part of the work unit.

4. The neural processor circuit of claim 1, wherein the operation unit of the neural engine circuit comprises a multiply-accumulator including an accumulator and a multiply-add circuit.

5. The neural processor circuit of claim 1, wherein the fourth rasterizer circuit of the neural engine circuit is further configured to send the output data to the data buffer.

6. The neural processor circuit of claim 1, wherein the kernel fetcher circuit is shared by the neural engine circuit and one or more other neural engine circuits.

7. The neural processor circuit of claim 1, wherein the neural processor circuit further comprises a task manager configured to send task information to the first rasterizer circuit, the second rasterizer circuit, the third rasterizer circuit, and the fourth rasterizer circuit.

8. The neural processor circuit of claim 1, wherein the neural engine circuit is further configured to:
determine whether the second portion of input data stored in the input buffer has been entirely processed; and
in response determining that the second portion of input data has not been entirely processed, forward a fourth portion of input data selected from the second portion of input data to the operation unit of the neural engine circuit for processing to generate another output data based on the fourth portion of input data.

9. The neural processor circuit of claim 8, wherein the fourth portion of input data and the third portion of input data are a part of the second portion of input data, and wherein the fourth portion of input data is generated by shifting the second portion of input data stored in the input buffer.

10. The neural processor circuit of claim 1, wherein:
the neural engine circuit is further configured to determine whether the second portion of input data stored in the input buffer has been entirely processed; and
in response determining that the second portion of input data has been entirely processed, the second rasterizer circuit is further configured to cause the data buffer to send a fourth portion of input data selected from the first portion of input data to the neural engine circuit for processing.

11. The neural processor circuit of claim 10, wherein the first portion of input data comprises a tile of input data, the second portion of input data comprises a first work unit of the tile of input data, and the fourth portion of input data comprises a second work unit of the tile of input data.

12. A method for processing input data by a neural processor circuit, comprising:
causing, by a first rasterizer circuit of a data reader, the data reader to receive a first portion of input data from a system memory external to the neural processor circuit;
storing the first portion of input data in a data buffer;
causing, by a second rasterizer circuit of the data buffer, the data buffer to send a second portion of input data selected from the first portion of input data to a neural engine circuit the neural processor circuit;
causing, by a third rasterizer circuit of a kernel fetcher circuit, the kernel fetcher circuit to receive a kernel from the system memory and to send the kernel to the neural engine circuit;
storing, by a fourth rasterizer circuit of the neural engine circuit, the second portion of input data in an input buffer of the neural engine circuit; and
forwarding a third portion of input data selected from the second portion of input data to an operation unit of the neural engine circuit for processing to generate output data based on the third portion of input data and the kernel.

13. The method of claim 12, wherein the first portion of input data comprises a tile of input data, the second portion of input data comprises a work unit of the tile of input data, and the third portion of input data is a part of the work unit.

14. The method of claim 12, wherein the operation unit of the neural engine circuit comprises a multiply-accumulator including an accumulator and a multiply-add circuit.

15. The method of claim 12, further comprising:
sending the output data to the data buffer.

16. The method of claim 12, wherein the kernel fetcher circuit is shared by the neural engine circuit and one or more other neural engine circuits.

17. A system, comprising:
a system memory configured to store input data; and
a neural processor circuit external to the system memory, comprising:
a neural engine circuit;
a data buffer;
a data reader comprising a first rasterizer circuit configured to cause the data reader to receive at least a first portion of input data from the system memory and to store the first portion of input data in the data buffer, wherein:
the data buffer comprises a second rasterizer circuit configured to cause the data buffer to send a second portion of input data selected from the first portion of input data to the neural engine circuit; and
the neural engine circuit comprises a third rasterizer circuit, an input buffer, and an operation unit, wherein the third rasterizer circuit is configured to store the second portion of input data in the input buffer and to forward a third portion of input data selected from the second portion of input data to the operation unit for processing to generate output data based on the third portion of input data.

18. The system of claim 17, wherein the neural processor circuit further comprises a kernel fetcher circuit comprising a fourth rasterizer circuit configured to cause the kernel fetcher circuit to receive a kernel from the system memory and to send the kernel to the neural engine circuit, and wherein the neural engine circuit is configured to generate the output data based on the third portion of input data and the kernel.

19. The system of claim 17, wherein the first portion of input data comprises a tile of input data, the second portion of input data comprises a work unit of the tile of input data, and the third portion of input data comprises a part of the work unit.

20. The system of claim 17, wherein the third rasterizer circuit of the neural engine circuit is further configured to send the output data to the data buffer.
